(19) United States
(12) Patent Application Publication
(10) Pub. No.: US 2018/0315118 A1
(43) Pub. Date: Nov. 1, 2018

(54) REAL ESTATE TRADE SYSTEM AND OPERATING METHOD THEREOF

(71) Applicant: Seung Hwa LEE, Gimpo-si, Gyeonggi-do (KR)

(72) Inventor: Seung Hwa LEE, Gimpo-si, Gyeonggi-do (KR)

(21) Appl. No.: 15/770,184

(22) PCT Filed: Feb. 6, 2013
(86) PCT No.: PCT/KR2013/000936

§ 371 Date: Apr. 20, 2018

(30) Foreign Application Priority Data
Feb. 10, 2012 (KR) 10-2012-0013809

(51) Int. Cl. G06Q 30/08; G06Q 50/16

(52) U.S. Cl. CPC G06Q 30/08; G06Q 50/16

(57) ABSTRACT

According to one embodiment of the present invention, the method for operating a real estate sales transaction system comprises setting up a transaction system for real estate which is to be registered for sale in order to sell the real estate; setting the bid cost and number of bidders for the sale of the real estate according to the transaction system which was set up; receiving the bid cost for the real estate from a plurality of bidders, and receiving bid information related to the transaction of the real estate; according to the real estate transaction system, analyzing a first information group including at least one from among the bid information, the bid cost, and the number of bidders, and determining whether to conduct a transaction on the real estate; selecting a bidder according to the determined results from among the plurality of bidders when the transaction is conducted on the real estate; and processing the sale for the selected bidder and refunding a certain percentage to unsuccessful bidders.

### TECHNICAL FIELD

The present invention relates to a technique for real estate sales at a reasonable price and at the desired time, and more particularly, to real estate sales transaction system for determining a reasonable selling price together with a seller, publishing the real estate for sale with an amount obtained by multiplying the selling price by a variable set percentage, allowing a variable number of buyers to perform bidding with a small price, and thus selecting one successful bidder among them, in which a winning bid number is extracted by a random method such as a 64˜256 BIT algorithm method or arrow shooting method through live broadcasting at a specific time to provide a higher reliability than the existing methods, whereby the seller can dispose his/her real estate at the reasonable price within the desired period and a buyer can choose the real estate to suit his/her taste and region and thus be given the opportunity to buy expensive real estate at a reasonable price.

### BACKGROUND

Generally, in the sale of real estate, the seller has a difficulty in determining the time to sell the real estate because the price of the real estate at the time of the sale is determined by market situations or negotiations with brokers or buyers. As the real estate bubble deflates and the real estate market shrinks, the seller cannot sell the real estate at a reasonable price and at the desired time so that he/she is likely to become house poor, whereby the national economy will be seriously impacted.

In addition, since properties for rent and government-sponsored apartments (Bogeumjari in Korean) are still expensive for ordinary people due to inflation and because buyers have interest rate anxiety, buyers are looking for real estate at a low monthly cost.

In addition, a large number of construction companies that have invested in PF loans have also entered into a crisis of bankruptcy because the companies are under financial stress and worse financial structure due to an increase in unsold apartments.

In addition, controversies over manipulation in gambling industries have always been raised, and thus distrust of the people continues to increase, and royalties to be paid and the spread of illegality caused by using lottery system are serious problems on Korean economy.

### DISCLOSURE

### Technical Problem

Accordingly, the present invention has been made keeping in mind the above problems occurring in the prior art, and an object of the present invention is to provide a real estate sales transaction system that enables: a seller to sell his/her own real estate at the desired time and thus avoid becoming house poor; a buyer who doesn't own a house to be given the opportunity to buy real estate in his/her desired region at an inexpensive price, and each company in bankruptcy crisis to get out of a bad financial situation by disposing unsold apartments.

Another object of the present invention is to provide a real estate sales transaction system that is preferable to most people who have disputed over real estate, in which a winning bid number is extracted using a random method such as a 64˜256 BIT algorithm method or arrow shooting method through a live broadcasting at a specific time to select a fair and definite bidder, thereby providing a higher reliability than existing gambling methods, replacing illegal gambling behaviors, and solving the problems described above.

### Technical Solution

In order to accomplish the above object, the present invention provides a method for operating a real estate sales transaction system, the method includes setting up a transaction system for real estate which is to be registered for sale in order to sell the real estate; setting the bid cost and number of bidders for the sale of the real estate according to the transaction system which was set up; receiving the bid cost for the real estate from a plurality of bidders, and receiving bid information related to the transaction of the real estate; according to the real estate transaction system, analyzing a first information group including at least one from among the bid information, the bid cost, and the number of bidders, and determining whether to conduct a transaction on the real estate; selecting a bidder according to the determined results from among the plurality of bidders when the transaction is conducted on the real estate; and processing the sale for the selected bidder and refunding a certain percentage to unsuccessful bidders.

In order to accomplish the above object, the present invention provides a real estate sales transaction system, the system includes an electronic transaction server, wherein the electronic transaction server includes a transaction system setup unit for setting up a transaction system for a real estate that is to be registered for sale in order to sell the real estate; a bid registration management unit for receiving bid costs for the real estate from a plurality of bidders and receiving bid information related to the transaction of the real estate to perform a bid registration process; a transaction conduct determination unit for analyzing a first information group including at least one from among the bid information, the bid cost, and the number of bidders according to the real estate transaction system to determine whether o not to conduct a transaction on the real estate; a transaction/refund processing unit for processing the sale for a bidder selected from among the plurality of bidders and refunding a certain percentage to unsuccessful bidders when the transaction is conducted on the real estate, and the bid costs and the number of bidders for the sale of the real estate are adjusted according the transaction system set for the real estate.

### Advantageous Effects

The real estate sales transaction system according to the present invention is beneficial to buyers who want to buy expensive real estate at an inexpensive price during a real estate bubble and to sellers and construction companies who can dispose of real estate at a reasonable price within a desired period when they are in a crisis in which they cannot sell the real estate even though the real estate for sale has not been sold in the real estate market that is shrinking due to economic instability.

In addition, the present invention has advantages of providing a real estate sales transaction system that is preferable to most people who have disputed over real estate, in which a winning bid number is extracted using a random method such as a 64˜256 BIT algorithm method or arrow shooting method through live broadcasting at a specific time to fairly select a bidder, thereby providing higher reliability than the existing gambling methods, replacing illegal gambling behaviors, and solving the problems described above.

### BRIEF DESCRIPTION OF THE DRAWINGS

FIG. 1 is an overall configuration diagram illustrating a real estate lottery sales system according to an embodiment of the present invention.

FIG. 2 is a block diagram illustrating a set percentage calculation server of a real estate lottery sales system according to an embodiment of the present invention.

FIG. 3 is a block diagram illustrating an electronic transaction server of a real estate lottery sales system according to an embodiment of the present invention.

FIG. 4 is a block diagram illustrating a winning bid number extracting server of a real estate lottery sales system according to an embodiment of the present invention.

FIG. 5 is a flowchart illustrating a real estate sales transaction system according to an embodiment of the present invention.

FIG. 6 is a flowchart illustrating a real estate sales transaction system according to another embodiment of the present invention.

FIG. 7 is a flowchart illustrating a real estate sales transaction system according to another embodiment of the present invention.

FIG. 8 is a block diagram illustrating an implementation of an electronic transaction server in a real estate sales transaction system according to an embodiment of the present invention.

FIG. 9 is a block diagram illustrating a detailed implementation of the electronic transaction server of FIG. 8.

FIG. 10 is a block diagram illustrating an implementation of a set percentage calculation server in a real estate sales transaction system according to an embodiment of the present invention.

### BEST MODE

In order to fully understand the present invention, operational advantages of the present invention, and objects achieved by implementing the present invention, reference should be made to the accompanying drawings which illustrate preferred embodiments of the present invention.

Hereinafter, the present invention will be described in detail with reference to the preferred embodiments of the present invention with reference to the accompanying drawings. Like reference symbols in the drawings denote like elements.

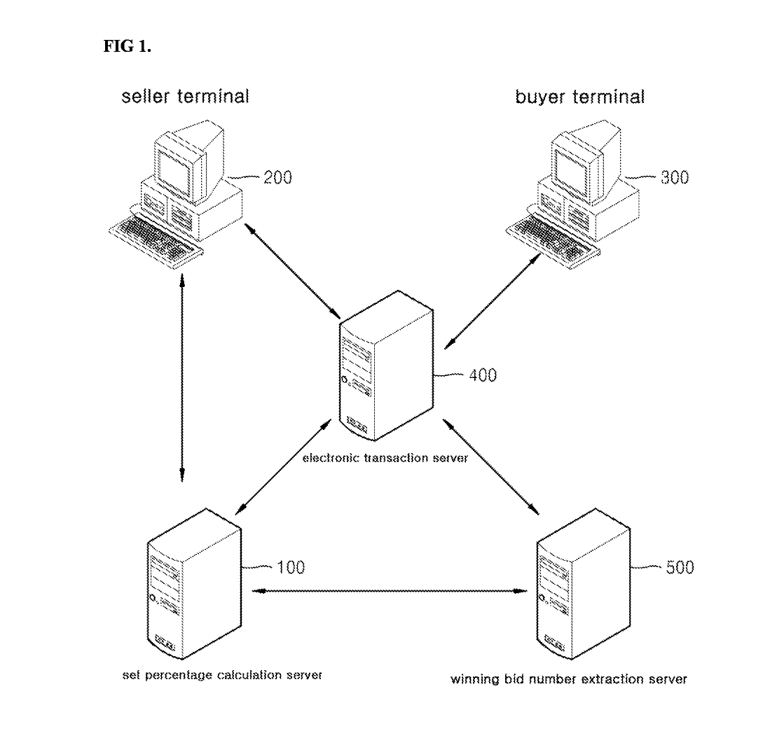

FIG. 1 is an overall configuration diagram illustrating a real estate lottery sales system according to an embodiment of the present invention. As shown in FIG. 1, a real estate lottery sales method according to an embodiment of the present invention includes:

a set percentage calculation server 100 for calculating a small price and a variable number of bidders by multiplying a variable set percentage by the selling price negotiated by conducting sale contract with a seller and searching sales information, and sending them to an electronic transaction server;

a seller terminal 200 for negotiating the sale period and the selling price of the real estate for sale, creating a real estate sales contract in a form (exclusive contract) that is separately provided, and providing various selling documents (registration certificate, seal certificate) that are necessary to perform real estate lottery sales;

an electronic transaction server 400 for receiving property-for-sale information arithmetically processed from the set percentage calculation server, notifying of the property-for-sale information, performing cost processing and qualification requirements of buyers bidding for the sale property, generating and sending a bid number to a qualified bidder, receiving the bid number from the winning bid number extraction server 500 when the number of bidders performing bids via the property-for-sale information arithmetically processed is satisfied, generating a winning bid result matched with the bid number, notifying of the winning bid result, sending it to the successful bidder, and storing the winning bid information;

a buyer terminal 300 for searching the electronic transaction server for the property-for-sale information arithmetically processed, performing a bid for a sale property that suits a buyer's taste, in which the bid is performed on a first-come, first-served basis if the number of bidders of the properties-for-sale arithmetically processed is limited, and making a request for a bid number through a public authentication procedure for processing the bid cost and adult authentication for a qualification of the buyer, thereby causing the bidder to be given one opportunity to bid for one sale property; and

a winning bid number extraction server 500 for receiving the property-for-sale information arithmetically processed by the set percentage calculation server to generate a specific time, extracting a winning bid number using a random method such as a 64˜256 BIT algorithm method or arrow shooting method through live broadcasting at the specific time so that the lottery is fairly and definitely performed, and sending it to the electronic transaction server.

As described above, although each server may be independently operated, the set percentage calculation server 100 and the winning bid number extraction server 500 may be modulated and mounted on the electronic transaction server 400 as needed.

The seller terminal and the buyer terminal mean unspecified individuals. A type of terminal is not limited if the terminal is connected to a web site such as a computer terminal or a mobile terminal and does not have a difficulty in using the system of the present invention.

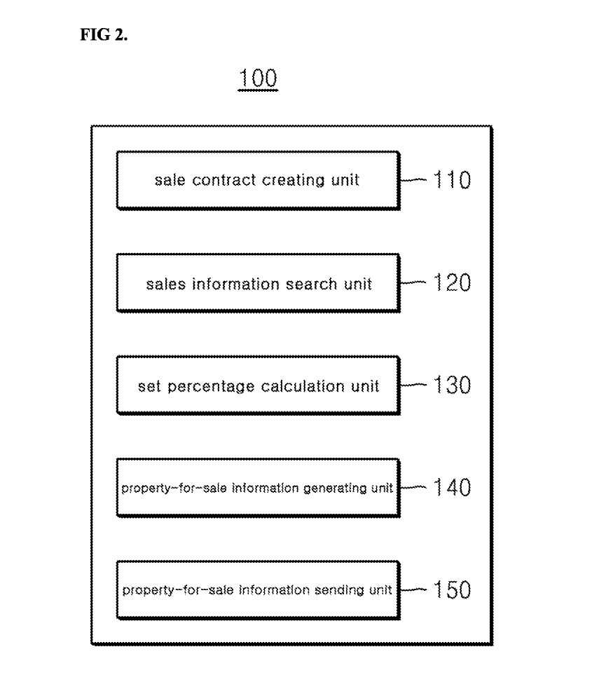

FIG. 2 is a block diagram illustrating a set percentage calculation server of a real estate lottery sales system according to an embodiment of the present invention.

As shown in FIG. 2, the set percentage calculation server 100 according to an embodiment of the present invention includes:

a sale contract creating unit 110 for creating information on the selling price and the sale period while charging an amount corresponding to a certain percentage of the selling price as a fee by referring to the real estate information set by the seller terminal 200;

a sales information search unit 120 for analyzing and searching the real sales price and ownership of the real estate by referring to information of the sale contract creating unit 110;

a set percentage calculation unit 130 for calculating the bid price and the number of bidders by multiplying the selling price negotiated on a basis of the sale contract creating unit 110 by a variable set percentage;

a property-for-sale information generating unit 140 for generating the property-for-sale information by referring to the bid price and the number of bidders calculated by the set percentage calculation unit 130 and the property-for-sale information analyzed from the sales information search unit 120; and

a property-for-sale information sending unit 150 for sending the property-for-sale information generated by the property-for-sale information generation unit 140 to the electronic transaction server 400.

Particularly, the set percentage calculation unit 130 calculates the bid price and the number of bidders by multiplying the selling price negotiated with sellers by the variable set percentage.

For example, when the selling price is determined as 300 million won, and the variable set percentage is provided as 0.03% of the selling price in the case of the bid cost and 1.5 times the selling price in the case of the number of bidders, the bid cost becomes 10,000 won and the number of bidders is 45,000, whereby 45,000 people may perform bids on a first-come, first-served basis. More specifically, the selling price depends on the use of the real estate such as apartment, house, land, shop, etc., the bid price is determined to be a small price by multiplying the selling price by a variable numerical value, that is, 0.00000001˜1, and the number of bidders is determined by multiplying the selling price by a variable numerical value, that is, 1 to an infinite number, whereby the and the number of bidders are varied for each sale property.

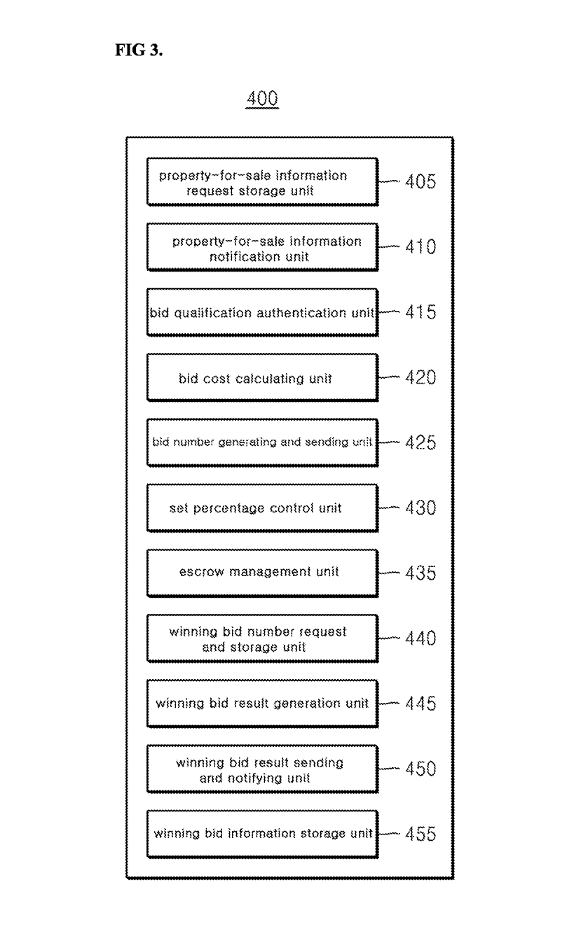

FIG. 3 is a block diagram illustrating an electronic transaction server 400 of a real estate lottery sales system according to an embodiment of the present invention.

As shown in FIG. 3, the electronic transaction server 400 according to an embodiment of the present invention includes:

a property-for-sale information request storage unit 405 for making a request for the property-for-sale information arithmetically processed and generated by the set percentage calculation server 100, and receiving and storing the property-for-sale information;

a property-for-sale information notification unit 410 for notifying a web site of the property-for-sale information stored by the property-for-sale information request storage unit 405;

a bid qualification authentication unit 415 for authenticating a qualification such as adult authentication and the real name of members who want to bid based on the property-for-sale information provided through the property-for-sale information notification unit 410;

a bid cost calculation unit 420 for calculating a bid price that is arithmetically processed for a member who has passed via the bid qualification authentication unit 415;

a bid number generating and sending unit 425 for generating and sending a unique bid number to the buyer terminal 420 when a cost processing completion signal is received from the bid cost calculation unit 420;

a set percentage control unit 430 for determining whether the bid price and the number of bidders calculated by the set percentage calculation server 100 are satisfied or not, and sending the condition, to a winning bid number request and storage unit 440 when they are satisfied and to an escrow management unit 435 when they are not satisfied;

the escrow management unit 435 for returning the bid cost to the bidding member because the condition is not satisfied in the set percentage control unit 430;

the winning bid number request and storage unit 440 for making a request for the winning bid number, and receiving and storing the number because the condition is satisfied in the set percentage control unit 430;

a winning bid result generation unit 445 for extracting information that matches with the winning bid number stored by the winning bid number request and storage unit 440, among the bid number information generated by the bid number generating and sending unit 425;

a winning bid result sending and notifying unit 450 for sending the information extracted by the winning bid result generation unit 445 to the buyer terminal 300 and notifying of the information to a web site; and

a winning bid information storage unit 455 for storing the overall information generated by the winning bid result generation unit 445, information on the members, result information, and the like, as proof of agreements that are determined by the system later.

In particular, the set percentage control unit 430 is controlled such that requirements of a and the number of bidders calculated by the set percentage calculation server 100 are satisfied, whereby the real estate lottery is fairly and definitely performed

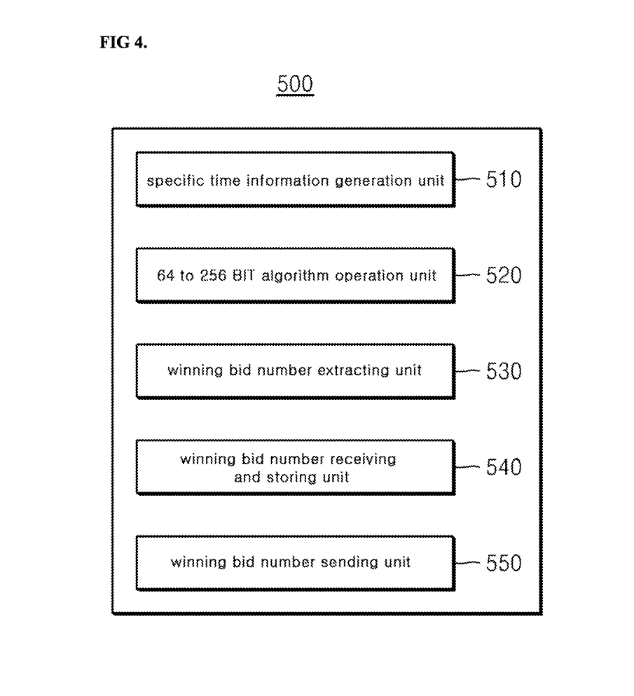

FIG. 4 is a block diagram illustrating a winning bid number extracting server 500 in a real estate lottery sales system according to an embodiment of the present invention.

As shown in FIG. 4, a winning bid number extraction server 500 according to an embodiment of the present invention includes:

a specific time information generation unit 510 for generating a specific time information to extract a bid number;

a 64 to 256 BIT algorithm operation unit 520 for performing random number processing to extract a fair winning bid number at the specific time generated by the specific time information generation unit 510;

a winning bid number extracting unit 530 for extracting the winning bid number in a random manner such as an arrow shooting method to extract the fair winning bid number at a specific time generated by the specific time information generation unit 510;

a winning bid number receiving and storing unit 540 for receiving and storing the winning bid number extracted from the 64 to 256 BIT algorithm calculation unit 520 and the winning bid number extracting unit 530; and

a winning bid number sending unit 550 for sending out the winning bid number generated by the winning bid number receiving and storing unit 540 to the electronic transaction server 400.

Particularly, the winning bid number extraction method described in the present invention may be a 64 to 256 BIT algorithm calculation unit 520 of random number processing type or a random method such as arrow shooting method, and also any random methods are possible if an open live broadcast can be run at a particular time and a winning bid number can be fairly extracted within that time in order to drive the system of the present invention.

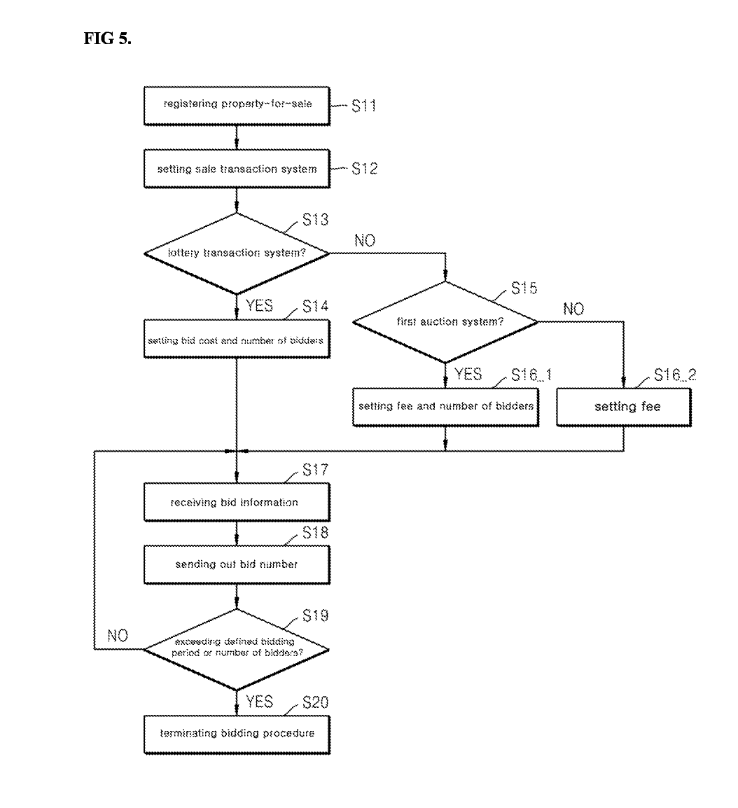

FIG. 5 is a flowchart illustrating a real estate sales transaction system according to an embodiment of the present invention. The various operations shown in FIG. 5 may be performed through the electronic transaction server, the set percentage calculation server and the winning bid number extraction server shown in FIG. 1, or may be performed by an electronic transaction server, a set percentage calculation server, and a winning bid number extraction server according to another embodiment of the present invention.

As shown in FIG. 5, a property for sale is registered for sale to sell the real estate (S11). For the purpose thereof, the sale period and selling price that are negotiated, and the real estate sales contract and various sales documents that are created may be registered in the electronic transaction server.

A sale transaction system is set up in order to sell the real estate registered for sale (S12). According to the embodiment of the present invention, the real estate may be sold according to various transaction systems, and the real estate transaction may be performed according to different transaction types for each real estate, so that the transaction may be performed according to the optimal transaction system for each real estate. In addition, according to the embodiment of the present invention, the sale transaction system may include a lottery transaction system and an auction transaction system, in which the auction transaction system may include a first auction transaction system limiting the number of bidders, and a second auction transaction system not limiting the number of bidders.

When the real estate is registered for sale and the method is set as described above, the bidders provide a certain cost, fee, and bid information so that a bidding process is performed. The bid information may include information related to the bidder or information related to the auction price in the case of the auction transaction system.

First, it is determined whether the corresponding transaction is conducted by the lottery transaction system for a predetermined real estate (S13). If it is determined that the real estate is sold by the lottery transaction system, the bid cost and the number of bidders are set (S14). The setting of the bid cost and the number of persons may be performed by the set percentage calculation server as described above, and the bid cost may be calculated by multiplying the real estate selling price by the variable set percentage. The number of bidders may be also set considering the variable set percentage. For example, when the number of bidders is set to 1.5 times the selling price of real estate and the selling price is 300 million won, the bid price is 10,000 won and the number of bidders is 45,000.

On the other hand, if the sale transaction is not performed by the lottery transaction system, it is determined whether the real estate is sold according to the first auction system (S15). If it is determined that the real estate is sold by the first auction system, a step of setting the fee and the number of bidders is performed (S16_1). In the case of transaction based on the auction system, the transaction may be performed according a method in which a bidder who presents the maximum auction price from among the auction prices offered by the respective bidders is selected, rather than the real estate lottery sales method.

According to an embodiment of the present invention, the first auction system is performed limiting the number of bidders, in which the number of bidders and fee (bid cost) that the bidder should pay are set to perform the transaction according to the auction system (for example, the first auction system). That is, the bid cost may be set differently according to types of real estates and selling prices, and the bid cost may be calculated by multiplying the selling price by the variable set percentage, or the limited number of bidders may be set considering the variable set percentage. For example, when the selling price of the real estate sale is 100 million won, the bid cost may be set to 10,000 won by multiplying the selling price by the variable set rate, and the number of bidders may be set to 10,000 considering the bid price and the real estate sale price.

Meanwhile, as a result of the determination, when the real estate is not sold according to the first auction system, it is determined that the real estate is sold by the second auction system. According to an embodiment of the present invention, the second auction system is performed not limiting the number of bidders. For this purpose, according to the auction system (for example, a second auction system), fee (bid cost) that the bidder should pay is set. The bid cost may also be set differently depending on types of the real estates and the selling prices, and the bid cost may be calculated by multiplying the selling price by the variable set percentage. For example, when an amount of real estate selling price is 100 million won, the bid cost may be set to 10,000 won by multiplying the selling price by the variable set percentage. The fee is set according to the calculated bid cost (S16_2).

When various kinds of information necessary for the bid are set according to the real estate transaction system described above, various kinds of bid information are received from the bidder who wants to buy the real estate (S17). Authentication processing is performed using information such as adult authentication and the real name of the members who want to perform a bid through the property-for-sale information notified for sale, and the cost processing operation necessary for the bid is performed. When the bid processing is normally completed, a bid number is generated and sent to the bidder (S19).

The bid processing described above is performed for a plurality of bidders, and then it is determined whether the bid period has elapsed. Alternatively, when the number of bidders is limited in systems such as the lottery transaction system or the first auction transaction system, it is determined whether or not the number of bidders exceeds the limit (S19). As a result of the determination, when the bidding period or the number of the bidders does not exceed the limit, the steps of receiving and processing the bid information from the bidders and sending the bid number continue to be performed. Then, when the bidding period or the number of the bidders exceeds the limit, the bidding procedure for real estate sales is terminated (S20).

The real estate sales transaction system according to the embodiment of the present invention described above is a bidding process performed by a plurality of bidders starting from property-for-sale registration, in which the transaction may be performed in various types in accordance with characteristics of each real estate, for example, whether transaction for each real estate is properly performed according to the auction system or the lottery method. In addition, it is possible to activate the real estate transaction by allowing the buyer to buy the real estate through a simple bid in the case of real estate that continues to be unsuccessful in bidding due to deterioration of buyers' interests, as well as to improve stability of the transaction.

In the above embodiment, a cost that the bidder should pay is defined as the bid cost in the lottery system, and the cost is defined as a fee in the first and second auction systems. However, a basic cost to be paid to participate in the bid may be defined as the bid cost.

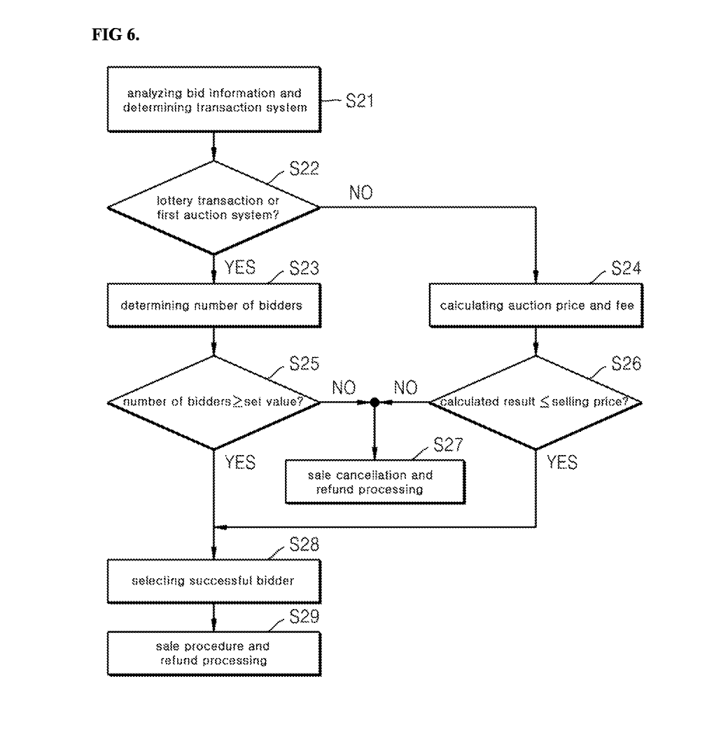

FIG. 6 is a flowchart illustrating a real estate sales transaction system according to another embodiment of the present invention. In the case of the embodiment of FIG. 6, there is shown an example of operations of selecting a successful bidder and conducting the sales procedure, starting from completion of the bidding step.

The electronic transaction server performs a real estate sales procedure using a plurality of bid information received and registered through the bidding procedure. First, a step of determining a transaction system for the real estate with analyzing the bid information is performed (S21). As described above, the transaction system according to the embodiment of the present invention may include a lottery transaction system, an auction system limiting the number of bidders (hereinafter referred to as a first auction system), and an auction system not limiting the number of bidders (hereinafter referred to as a second auction system).

First, it is determined whether the transaction system for the real estate is a lottery transaction or a first auction system (S22). That is, it is determined whether the transaction system for the real estate is the lottery transaction or the first auction system limiting the number of bidders, or the second auction system not limiting the number of bidders, as a result of the determination.

As a result of the determination, when the transaction system for the real estate is the lottery transaction or the first auction system, the number of bidders that enter a bid for the real estate is determined (S23). This may be determined by analyzing the bid information stored in the electronic transaction server as a database. Meanwhile, when the transaction system for the real estate is the second auction system, steps of extracting the auction price and the fee information from the bid information received through the bidding procedure, and then calculating the auction price and the fee are performed (S24).

When the number of bidders is determined in the lottery transaction or the first auction system, it is determined whether the number of bidders is equal to or greater than a predetermined set value (S25). That is, in the lottery transaction or the first auction system, whether or not the sale transaction is successful may be determined according to a result obtained by comparing the number of bidders with the predetermined set value. When it is equal to or greater than the predetermined value, it is determined that the sale transaction is conducted, and then a bidder selection process is performed (S28). The bidder selection process enables the fair extraction of a winning bid number at a specific time by extracting the winning bid number in a random manner or extracting the winning bid number using the BIT algorithm as described above.

On the other hand, when it is less than the predetermined set value, it is determined that the sale transaction is not conducted, and a step of refunding the bid costs deposited from the bidders with cancelling the sale is performed (S27). Specifically, the real estate that was registered for sale may be again registered for sale in the future, and herein it is possible to attempt the sale by variably adjusting the selling price or the sales transaction system.

Meanwhile, when the transaction system for the real estate is the second auction system, an operation of comparing the result obtained by calculating the auction price and the fee with a predetermined amount is performed (S26). As an example, an calculation operation of adding a maximum auction price selected from among the auction prices presented from a plurality of bidders and an amount obtained by adding the fees from all bidders is performed, and an operation of determining whether the calculated amount is equal to or greater than the selling price of the real estate is performed. However, the embodiment of the present invention need not be limited to this, and therefore it may be determined whether the calculated amount is equal to or greater than an amount obtained by adding the selling price of the real estate and a predetermined amount. The predetermined amount is a kind of contingent fee that is provided to a broker (or system operator) when a real estate sales transaction is conducted, and may be determined as, for example, an amount corresponding to a certain percentage (for example, 1%) of the selling price of the real estate. That is, the transaction may be conducted on the real estate when an amount obtained by adding the maximum auction price and a total of fees from all bidders is equal to or greater than an amount obtained by adding the real estate selling price and the above contingent fee.

Meanwhile, when the calculated amount is less than the selling price, the transaction may not be conducted on the real estate. In this case, an operation of refunding the bid costs deposited from the bidders with cancelling the sale is performed as in step S27 described above.

It is determined whether the sales transaction is conducted or not in different methods according to the transaction system that is set up for the real estate. When the sale transaction is conducted, a procedure of selecting a successful bidder is performed, a sale procedure is performed on the real estate with the successful bidder, and then refund processing procedure of distributing a part of the bid costs to unsuccessful bidders or distributing a part of the fees to the bidders is performed (S29).

Meanwhile, an example of the real estate transaction method according to the first auction system and the second auction system as the above-mentioned transaction system will be described using the following table.

TABLE 1

| | | |
|---|---|---|
| Selling price | Real sale price, reference to estimated value | A hundred million |
| | | won |
| Set percentage | Selling price* (one ten thousandth to one | Ten thousand won |
| | hundred thousandth) | |
| Fee | Set percentage = (normally ten thousand to | Ten thousand won |
| | hundred thousand won) | |
| The number of | Determined considering selling price and | Ten thousand |
| bidders | variable set percentage | |
| A total of fees | Normally same to selling price | A hundred million |
| | | won |
| Starting from a certain | Sale price * 1% | A million won |
| amount | | |
| Assistance to | Selling price-maximum bid price = assistance | Equal to or less |
| successful bidder | | than 99% |
| Payment from | Bid price + income tax + buying cost | Equal to or less |
| Successful bidder | | than 30% |

TABLE 2

| | | |
|---|---|---|
| Selling price | Real sale price, reference to estimated value | A hundred million won |
| Set percentage | Selling price*(one ten thousandth to one | Ten thousand won |
| | hundred thousandth) | |
| Fee | Set percentage = (normally ten thousand to | Ten thousand won |
| | hundred thousand won) | |
| The number of bidders | No limitation | |
| A total of fees | No limitation | |
| Starting from a certain | Sale price * 1% | A million won |
| amount | | |
| Assistance to | Selling price − maximum bid price = assistance | Equal to or less |
| successful bidder | | than 99% |
| Payment from | Bid price + income tax + buying cost | Equal to or less |
| successful bidder | | than 30% |
| Failure in bidding | Selling price − maximum bid price > a total of | |
| | fees + 3% | |

Table 1 shows an example of the real estate sales transaction according to the first auction system, in which the selling price of the real estate is 100 million won and an amount obtained by multiplying the selling price by a variable set percentage (for example, one ten thousandth to one hundred thousandth) is set as a fee for participating in the bid. For example, considering that the real estate selling price is set to 100 million won, and the fee for participating in the bid is set to 10,000 won, the number of bidders may be set to 10,000. Herein, when all the 10,000 bidders pay the fee, a total of bid fees is equal to 100 million won, which is equal to the selling price of the real estate. Each bidder will be able to participate in the auction process by paying the above fee, and provide information such as auction price (bid cost) to the electronic transaction server to practically buy the real estate, in addition to the fee.

The auction may be performed starting from a certain amount. For example, as shown in Table 1, the auction may be performed starting from one million won corresponding to 1% of the selling price. A bidder offering the maximum auction price is selected from among the bidders, and the successful bidder may pay the bid cost, income tax, and buying cost in addition to the fee, thereby buying the real estate. In addition, assistance to the successful bidder may correspond to an amount obtained by subtracting the bid price of the successful bidder from the selling price.

In the first auction system as shown in Table 1, the number of bidders is limited to 10,000. Accordingly, the electronic transaction server determines the number of bidders, and performs sale cancelling and refund processing operations when the number of bidders does not reach 10,000. Meanwhile, the seller of real estate is provided with real estate selling price by providing the amount corresponding to the auction price from the successful bidder and a portion of the fees from a large number of the bidders for an amount corresponding to a difference. In addition, the remaining portion of the fee may be refunded to a number of the bidders at a certain rate, except the contingent fee provided to the transaction broker (or system operator).

Table 2 shows an example of the real estate sales transaction according to the second auction system, in which the selling price of the real estate is 100 million won and an amount obtained by multiplying the selling price by a variable set percentage (for example, one ten thousandth to one hundred thousandth) is set as a fee for participating in the bid. Herein, since there is no restriction to the number of bidders, a larger number of bidders may participate in the real estate sales transaction, and thus a total of bid fee is also not limited.

According to the second auction system, when the number of the bidders is small so that a sum of the auction price and the total of fee is smaller than the selling price of the real estate, the sale transaction may not be conducted. In this case, the result obtained by summing the auction price and the total of fee is used to determine whether or not the transaction is conducted on the real estate. For example, the sales transaction may be not conducted when the selling price is greater than a sum of the maximum bid price and the total of fee, or the sales transaction may be conducted only when the sum of the maximum bid price, a the total of bid fee, and a certain percentage (for example, 3%) of the selling price is equal to or greater than the selling price, as shown in Table 2. Then, the sales transaction may be conducted through assistance to the successful bidder and payment from the successful bidder as in the first auction system described above.

Meanwhile, as in the above-described embodiment, conditions for determining whether or not the transaction is successfully conducted may be differently set for the lottery method and the first and second auction systems. Accordingly, among various information including the bid information, the bid cost, and the number of the bidders, the information used in the lottery method is referred to as a first information group, and the information used in the first and second auction systems are referred to as second and third information groups respectively.

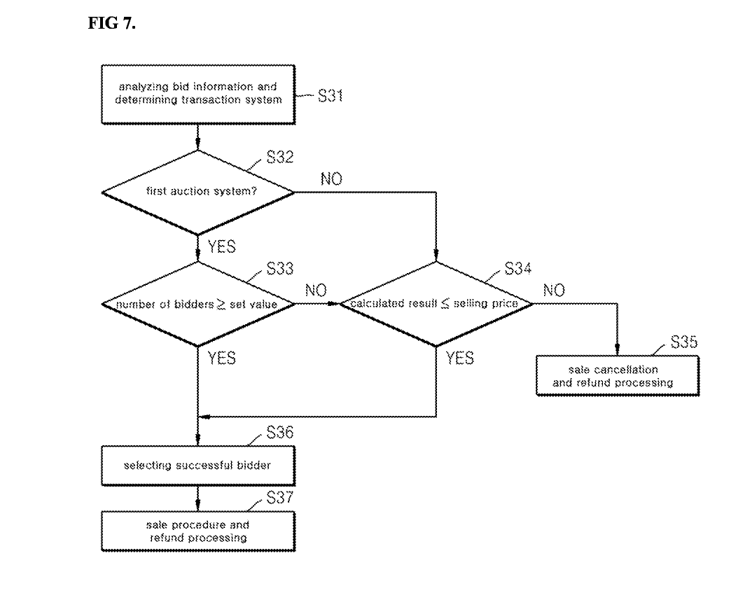

FIG. 7 is a flowchart illustrating a real estate sales transaction system according to another embodiment of the present invention. Referring to FIG. 7, in the real estate trading system according to the embodiment of the present invention, an example in which at least two transaction systems are automatically changed according to the bidding result will be described.

As shown in FIG. 7, a step of determining a transaction system for the real estate with analyzing the bid information is performed (S31). Assuming that a bidding procedure has been performed for the real estate through the auction system, it is first determined whether the bidding procedure is performed on the real estate through the first auction system (S32).

As a result of the determination, when the bidding procedure is performed on the real estate through the first auction system, the first auction system limits the number of bidders so that the number of the bidders is decided. Further, when the number of bidders is decided, it is determined whether the number of bidders is equal to or greater that the predetermined set value (S33). The predetermined set value may be set considering information such as selling price and variable set percentage as in the above embodiment.

When the bidding procedure is not performed on the real estate through the first auction system, it is determined that a bidding procedure has been performed on the real estate through the second auction system, and then subsequent operations are performed. Alternatively, when the number of bidders is less than the predetermined set value in step S33, the auction system is changed to the second auction system. An operation of comparing the result (calculated value) obtained by calculating the auction price and the fee with the predetermined amount to perform the real estate sales transaction according to the second auction system is performed (S34). When the calculated value is less than the selling price, the corresponding sales transaction may be not conducted, whereby the transaction cancelling and refund processing operations are performed (S35).

On the other hand, as described above, when the number of bidders is equal to or greater than the predetermined set value in the first auction system, or when the calculated value is equal to or greater than the selling price in the second auction system, the corresponding sales transaction may be conducted. Accordingly, the first auction system and the second auction system are automatically changed, and thus the real estate sales transaction is performed according to any one of the methods. After the successful bidder selection process is performed (S36), the real estate sale procedure is performed with the successful bidder, and a process of refunding a certain percentage is performed to distribute a part of the bid price to the bidder or to distribute a part of the fee to the bidder (S37).

According to the real estate sales transaction system in the embodiment of the present invention described above, a customer who wants to sell real estate may sell his/her real estate in various sales methods based on the characteristics of the real estate, and a customer who wants to buy real estate may attempt to buy the real state at a small price (lottery system) or attempt to buy real state via normal auction system (first and second auction systems). In addition, according to the real estate sales transaction system in the embodiment of the present invention, it is possible to activate real estate transactions with enhancing convenience and stability in transactions, by providing a convenient and stable real estate sales system to both of seller or buyer.

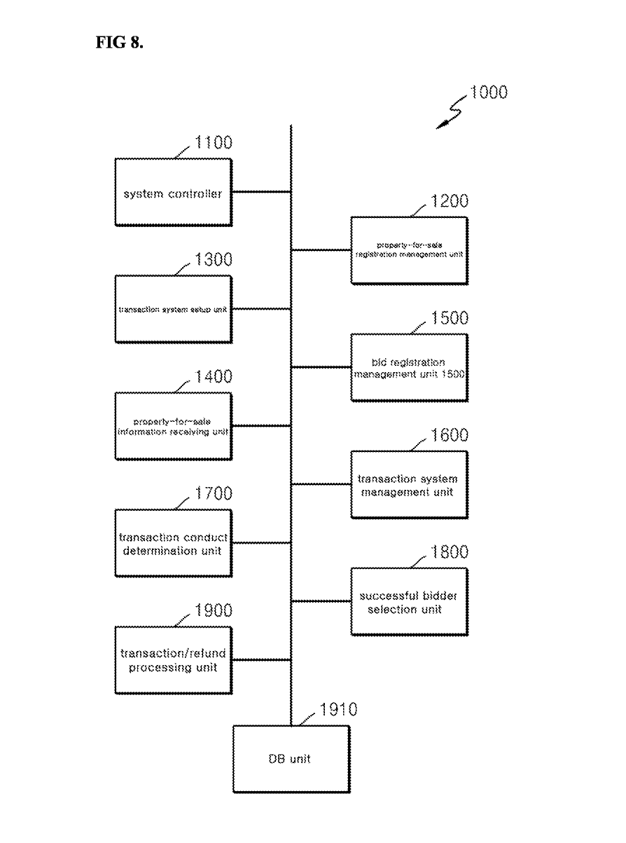

FIG. 8 is a block diagram illustrating an implementation of an electronic transaction server in a real estate sales transaction system according to an embodiment of the present invention. The system shown in FIG. 8 is an implement for performing the real estate sales transaction system described above with reference to FIGS. 5 to 7. Although each component shown in FIG. 8 may be different from component of various servers shown in FIGS. 2 to 4. However, each component shown in FIG. 8 may be included in components of various servers shown in FIGS. 2 to 4 or correspond (or is similar) to them. Alternatively, each component in FIG. 8 may be a concept including at least one of component of various servers shown in FIGS. 2 to 4.

As shown in FIG. 8, the electronic transaction server 1000 of the real estate sales transaction system includes a system control unit 1100, a property-for-sale registration management unit 1200, a transaction system setup unit 1300, a property-for-sale information receiving unit 1400, and a bid registration management unit 1500. The electronic transaction server 1000 may further include a transaction system management unit 1600, a transaction conduct determination unit 1700, a successful bidder selection unit 1800, and a transaction/refund processing unit 1900, and the electronic transaction server 1000 may further include a database unit 1910 for storing various information related to the real estate sales transaction in a database according to the embodiment of the present invention.

The system control unit 1100 may control overall operations of the electronic transaction server 1000 and control operations of various components included in the electronic transaction server 1000. The property-for-sale registration management unit 1200 may register information related to the real estate that is to be sold, and register the sale period and the selling price negotiated, or the real estate sales contract created, and various documents.

The transaction system setup unit 1300 sets a transaction system for each real estate that is to be sold. According to the embodiment of the present invention, the sales transaction is conducted according to at least two transaction systems for each real estate so that optimal transaction system may be performed on each real estate. For example, the property-for-sale transaction system may include at least two methods such as the lottery transaction system and the auction transaction system, in which the auction transaction system may include a first auction transaction limiting the number of bidders and a second auction transaction not limiting the number of bidders.

The property-for-sale information receiving unit 1400 receives the property-for-sale information such as the bid cost and the number of bidders set for the corresponding real estate. The property-for-sale information receiving unit 1400 may receive the property-for-sale information from a server (for example, a certain percentage calculation server) positioned outside the electronic transaction server 1000 of the real estate sales transaction system according to the present invention. Although not shown, the electronic transaction server 1000 may perform the operation of setting the bid cost and the number of bidders for the real estate, in which the structure of the property-for-sale information receiving unit 1400 may be omitted.

As each real estate is registered for sale and a transaction system for the corresponding real estate is set, a bidding process is performed according to the set transaction system. The bid registration management unit 1500 performs a registration process using bid information such as a predetermined bid cost, fee, and auction price provided from the bidders. The authentication process is performed using information such as adult authentication and the real name of the member who wants to perform the bid through notified properties-for-sale information, the cost processing operation necessary for the bid is performed, and when the bidding process is normally completed, the bid number is generated and sent to the bidder. In addition, for the purpose of normal bidding process, the bid registration management unit 1500 may determine whether the bid period or the number of bidders exceeds the bid period or the defined number of bidders defined for the corresponding real estate.

The electronic transaction server 1000 that performs the bid performs a successful bidding process for the corresponding real estate after completing the bidding process. The transaction system management unit 1600 determines transaction system set for the corresponding real estate to perform the successful bidding process, and outputs the determination result. The determination result is provided to another component in the electronic transaction server 1000, whereby the successful bidding process may be performed according to the transaction system set for the real estate.

In addition, the transaction system management unit 1600 allows the real estate sales transaction to be flexibly performed so that the transaction systems may be automatically changed based on the successful bid process result so as to reduce a possibility of an unsuccessful bid. For example, the transaction system management unit 1600 controls to determine whether the transaction for the corresponding real estate is conducted (whether conditions for the successful bidding process are satisfied) and change the transaction system correspondingly to the real estate according to the determination. When the transaction system for the real estate is currently set as the first auction system, it is determined whether the transaction is conducted in accordance with whether the number of bidders is equal to or more than a predetermined set value. The determination is provided to the transaction system management unit 1600, and then the transaction system management unit 1600 changes the transaction system to the second auction system. Accordingly, a result obtained by calculating the maximum auction price among the auction prices received from the bidders and fees from the bidders is compared with a predetermined amount to determine whether or not the transaction for the real estate is conducted or not. According to the determination, the successful bidding process is performed hereinafter.

The transaction success determination unit 1700 determines whether the transaction for the real estate is conducted or not using the successful bidding result according to each transaction system as described above. As described above, in the case of the lottery transaction system or the first auction system, the transaction success determination unit 1700 determines the number of bidders who bid on the real estate using the bid result, and may determine whether the transaction is conducted or not in accordance with a result of comparing the number of bidders with the predetermined set value. Meanwhile, in the case of the second auction system, the transaction success determination unit 1700 extracts auction price and fee information from the bid information received through the bidding process to calculate the auction price and the fee, whereby it is possible to determine whether the transaction is conducted or not by comparing the calculated amount with a predetermined amount.

The successful bidder selection unit 1800 selects the successful bidder by extracting the winning bid number in a random method or extracting the winning bid number using a BIT algorithm. As described above, when the winning bid number extraction server is positioned outside the electronic transaction server 1000, the winning bid number may be provided from the winning bid number extraction server to the electronic transaction server 1000, and the successful bidder selection unit 1800 performs the successful bidder selecting operation using the received winning bid number. The transaction/refund processing unit 1900 processes the sales transaction with the successful bidder according to the successful bidding result, and performs a refund processing operation of refunding a certain percentage of the bid price to unsuccessful bidders or a part of the fee to the unsuccessful bidders.

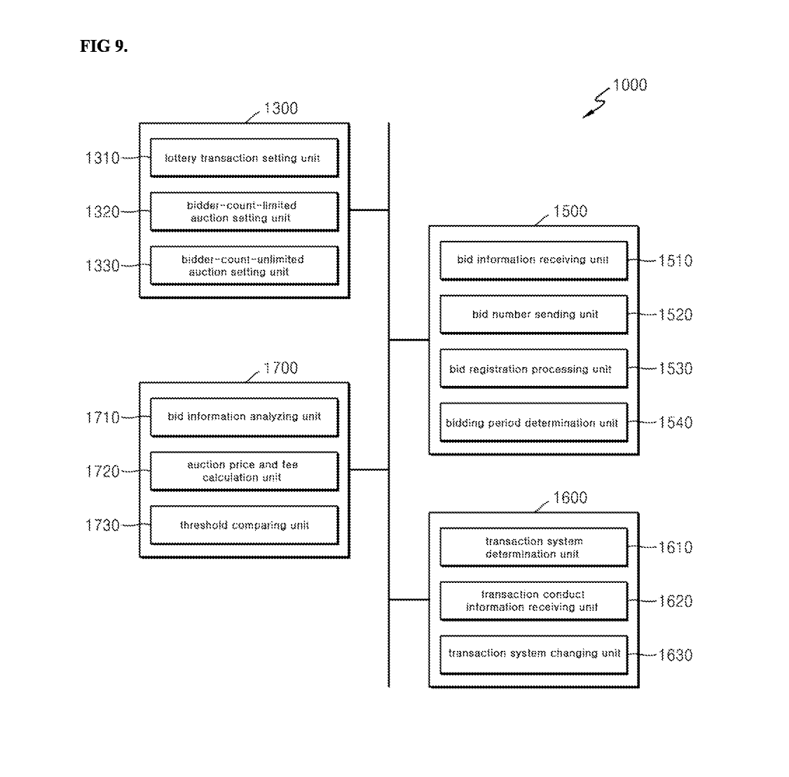

FIG. 9 is a block diagram illustrating a detailed implementation of the electronic transaction server of FIG. 8. For the purpose of easy explanation, an implementation in FIG. 9 includes a transaction system setup unit 1300, a bid registration management unit 1500, a transaction system management unit 1600, and the transaction conduct determination unit 1700.

The transaction system setup unit 1300 may include a lottery transaction setting unit 1310, a bidder-count-limited auction setting unit 1320, and a bidder-count-unlimited auction setting unit 1330. Each setting unit sets the transaction system for each real estate using information on the corresponding real estate (for example, bid price, fee, the number of bidders limited, and the like), and sets information such as bid price, fee, the number of bidders limited, and the like according to corresponding transaction system.

The bid registration management unit 1500 may include a bid information receiving unit 1510, a bid number sending unit 1520, a bid registration processing unit 1530, and a bid period determination unit 1540. The bid information receiving unit 1510 receives bid information such as predetermined bid cost or fee, auction price, and the like provided from the bidders. When the authentication process is normally performed for an individual bidder, the bid number sending unit 1520 generates a bid number and sends it to the bidder. The bid registration processing unit 1530 performs an operation of registering various bid information from the bidder, a bid number sent to the bidder, and the like, in the system. In addition, the bid period determination unit 1540 determines the bid period for the real estate transaction, so that the bid may be normally registered or not be registered according to whether the period exceeds the limit or not.

Meanwhile, the transaction system management unit 1600 may include a transaction system determination unit 1610, a transaction conduct information receiving unit 1620, and a transaction system changing unit 1630. The transaction system determination unit 1610 determines the transaction system set for the corresponding real estate by referring to information related to sales transaction that is stored in the database unit 1910 in the system and outputs the determination result. The determination result may be used by other various components in the system.

The transaction conduct information receiving unit 1620 receives information related to whether the transaction is conducted or not from the transaction conduct determination unit 1700, and causes the transaction system to be changed based on the information. The transaction system changing unit 1630 performs a changing operation, such as changing the transaction system from lottery method to the auction system, or from the first auction system to the second auction system, using the information from the transaction conduct information receiving unit 1620. Then, the transaction system for the real estate is automatically changed so that the transaction procedure may be performed according to the changed method.

The transaction conduct determination unit 1700 may include a bid information analyzing unit 1710, an auction price and fee calculating unit 1720, and a threshold comparing unit 1730. The bid information analyzing unit 1710 analyzes the transaction system set for the real estate, and information such as the number of bidders, the auction price, and the fee registered.

The auction price and fee calculation unit 1720 performs calculation using information such as the auction price and the fee analyzed. Specifically, in order to determine whether the transaction is conducted or not according to the second auction system, the auction price and fee information are extracted from the bid information so that the auction price and the fee are calculated. The threshold comparing unit 1730 performs a comparison operation of determining whether the transaction is conducted or not using the information related to the transaction system, and the information such as the number of bidders, the auction price, and the fee registered. For example, it is determined whether the number of bidders is equal to or larger than a predetermined set value in the lottery system or the first auction system, and it is determined whether the result from the auction price and fee calculation unit 1720 is equal to or larger than the selling price of the corresponding real estate (or amount obtained by summing the selling price and a certain contingent fee) in the second auction system. The threshold may be a value corresponding to the predetermined set value described above or an amount corresponding to the selling price of the real estate.

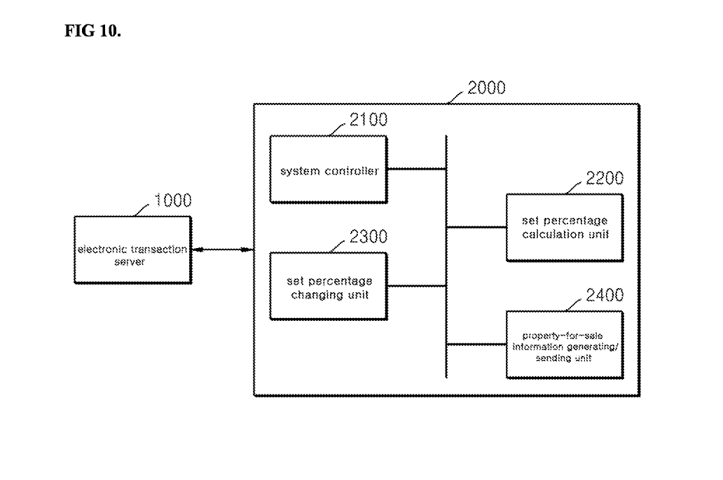

FIG. 10 is a block diagram illustrating an implementation of a set percentage calculation server in a real estate sales transaction system according to an embodiment of the present invention. The real estate sales transaction system according to an embodiment of the present invention may include a set percentage calculation server 2000, in addition to the electronic transaction server 1000, and the set percentage calculation server 2000 may further include a set percentage calculation unit 2200, a set percentage changing unit 2300, and an property-for-sale information generating/sending unit 2400, in addition to a system control unit 2100 for controlling overall operations of the system.

The set percentage calculation unit 2200 performs an operation of calculating the bid price and the number of bidders by multiplying the negotiated selling price of the real estate by a variable set percentage, and provides the result to the electronic transaction server 1000. The set percentage changing unit 2300 performs an operation of changing the set percentage to adjust the bid price (or fee) and the number of bidders according to the sales transaction, and provides the changed set percentage to the set percentage calculation unit 2200. The property-for-sale information generating/sending unit 2400 generates property-for-sale information including the information relating to the bid price and the number of bidders calculated and refers to the property-for-sale information analyzed from the sales information search unit 120 to send them to the electronic transaction server 1000.

While the present invention has been particularly shown and described with reference to exemplary embodiments thereof, it will be understood by those skilled in the art that various changes and modifications may be made without departing from the scope of the invention. Accordingly, the true scope of the present invention should be determined by the technical idea of the appended claims.

What is claimed is:

1. A method for operating a real estate sales transaction system, the method comprising:
setting up a transaction system for real estate which is to be registered for sale in order to sell the real estate; setting the bid cost and number of bidders for the sale of the real estate according to the transaction system which was set up; receiving the bid cost for the real estate from a plurality of bidders, and receiving bid information related to the transaction of the real estate; according to the real estate transaction system, analyzing a first information group including at least one from among the bid information, the bid cost, and the number of bidders, and determining whether to conduct a transaction on the real estate; selecting a bidder according to the determined results from among the plurality of bidders when the transaction is conducted on the real estate; and processing the sale for the selected bidder and refunding a certain percentage to unsuccessful bidders.

2. The method according to claim 1, wherein the transaction system for the real estate includes at least two transaction systems, and the transaction system is changed to another system for the real estate when the transaction is determined not to be conducted on the real estate, and the method further includes a step of analyzing a second information group including at least one of the bid information, the bid cost, and the number of bidders according to the changed system and re-determining whether to conduct the transaction on the real estate.

3. The method according to claim 1, wherein the real estate transaction system includes a lottery system that selects a successful bidder by randomly extracting any one bidder from among bidders which have paid the bid cost, a first auction system that selects a successful bidder from auction prices presented by a defined number of bidders, and a second auction system that selects a successful bidder from auction prices presented by a non-defined number of bidders.

4. The method according to claim 3, wherein it is determined whether the transaction is conducted or not on the real estate based on an operation of comparing the number of bidders with a first threshold in the case of the lottery system and the first auction system, and it is determined whether the transaction is conducted or not on the real estate based on an operation of comparing a result obtained by calculating the bid cost and the auction price with a second threshold in the case of the second auction system.

5. The method according to claim 1, wherein whether the transaction is conducted or not on the real estate is determined based on an amount obtained by summing the bid costs from the plurality of bidders and the selling price of the real estate, the processing the sale is performed by providing the selling price of the bid costs to a real estate buyer, and the refunding is performed by refunding a certain percentage of the bid cost except the selling price to the unsuccessful bidders.

6. A real estate sales transaction system, the system comprising:
an electronic transaction server,
wherein the electronic transaction server includes a transaction system setup unit for setting up a transaction system for a real estate that is to be registered for sale in order to sell the real estate; a bid registration management unit for receiving bid costs for the real estate from a plurality of bidders and receiving bid information related to the transaction of the real estate to perform a bid registration process; a transaction conduct determination unit for analyzing a first information group including at least one from among the bid information, the bid cost, and the number of bidders according to the real estate transaction system to determine whether o not to conduct a transaction on the real estate; a transaction/refund processing unit for processing the sale for a bidder selected from among the plurality of bidders and refunding a certain percentage to unsuccessful bidders when the transaction is conducted on the real estate, and the bid costs and the number of bidders for the sale of the real estate are adjusted according the transaction system set for the real estate.

7. The system according to claim 6, wherein the transaction system for the real estate includes at least two transaction systems, the electronic transaction server further includes a transaction system management unit for receiving information related to whether or not to conduct the transaction on the real estate and changing the transaction system for the real estate to another system when the transaction is not conducted on the real estate, and the transaction conduct determination unit analyzes a second information group including at least one of the bid information, the bid cost, and the number of bidders to re-determine whether to conduct the transaction on the real estate.
